(19) United States
(12) Patent Application Publication
(10) Pub. No.: US 2007/0047140 A1
(43) Pub. Date: Mar. 1, 2007

(54) Electroplated multiple layer soft magnetic materials with high magnetic moment

(76) Inventors: Ibro M. Tabakovic, Edina, MN (US); Jose Antonio Medina, Pleasanton, CA (US); Mark T. Kief, Lakeville, MN (US)

Correspondence Address: Seagate Technology LLC, 7801 Computer Ave S, Bloomington, MN, 55435, US

(21) Appl. No.: 11/215,373

(22) Filed: Aug. 29, 2005

(51) Int. Cl. G11B 5/147

(52) U.S. Cl. 360/126

(57) ABSTRACT

The present invention relates to a magnetic structure for writing. The magnetic structure includes a non-magnetic layer, a first magnetic layer electroplated adjacent the non-magnetic layer, a second magnetic layer electroplated adjacent the first magnetic layer, and a third magnetic layer electroplated adjacent the second magnetic layer. The first magnetic layer has a first saturation magnetization and a first coercivity. The second magnetic layer has a second saturation magnetization and a second coercivity. The third magnetic layer has a first saturation magnetization and a first coercivity.

### FIELD OF THE INVENTION

The present invention relates generally to an electroplated multiple layered magnetic structure, and more particularly, but not by limitation to, a multiple layered magnetic structure for use in a writing pole of a magnetic head.

### BACKGROUND OF THE INVETION

Magnetic heads typically include both a write element and a read element. The read element includes a magnetoresistive (MR) or giant magnetoresistive (GMR) element for reading information from a recording layer of a recording medium (i.e., a magnetic disc). The write element is configured to generate magnetic fields that align magnetic moments of the recording layer to represent bits of data.

Write elements include top and bottom poles, each of which have a pole tip. The pole tips are separated by a gap layer at an air-bearing surface (ABS), which faces the recording medium. A conductive coil surrounds a section of a magnetic circuit formed by the top and bottom poles. Current signals in the coil induce magnetic signals in the top and bottom poles, which are used to write data to the recording medium. The write element includes perpendicular or longitudinal writing and can function with a single pole.

Magnetic recording techniques include perpendicular and longitudinal recording techniques. Write elements configured for perpendicular recording typically utilize the top pole as a writing pole through which the magnetic signals are conducted in a manner that orients magnetic moments in the recording medium perpendicularly to the surface of the recording medium. Longitudinal write elements utilize both the top and bottom poles to record data to the recording medium. The magnetic signals of write elements configured for longitudinal recording fringe between the top and bottom poles and orient the magnetic moments of the recording layer longitudinally or parallel to the surface of the recording medium. Accordingly, both the top and bottom poles of longitudinal write elements operate cooperatively as writing poles.

There is a continuous demand for improvements to perpendicular and longitudinal write elements, including higher areal density recording capability, which corresponds to the amount of data that can be recorded in a given area of the recording layer. The areal density recording capability of write elements can be increased by reducing the size of the magnetic bits recorded to the recording medium. This is accomplished by reducing the surface area of the pole tip of the writing pole and by increasing the linear density and recording frequency at which the data is recorded. However, saturation magnetization, coercivity, and permeability along with other properties of the writing pole (perpendicular write elements) or writing poles (longitudinal write elements) limit the areal recording density capability of the write element.

In general, the saturation magnetization of the material forming the writing pole places a limit on the amount of magnetization, or magnetic flux density, that can be conducted therethrough. The use of materials with a high saturation magnetization for writing pole tips allows for the generation of higher magnetic fields in the recording layer, larger magnetic field gradients, and faster effective rise times in the magnitude of the magnetic field at the writing pole tips. Additionally, improvements, such as narrower pulse widths, smaller erase bands, and straighter recorded bit transitions are possible if materials having a high saturation magnetization are used for the writing poles. All the above advantages become even more important when recording at high areal densities.

The coercivity of the material forming the writing pole is related to how quickly the magnetization of the material can change direction. In general, materials having a lower coercivity can change the direction of their magnetizations more quickly than materials having a higher coercivity. Accordingly, it is desirable to utilize materials having a low coercivity for the writing poles in order to accommodate high frequency recordings and, thus, high areal density recordings.

The recording head operates more effectively when the writing pole(s) has properties that include a high saturation magnetization, a small coercivity, and a low remanence. The high saturation magnetization allows high magnetization writing on the recording media.

The present invention provides a solution to these and other problems and offers other advantages over the prior art.

### SUMMARY OF THE INVENTION

The present invention relates to a magnetic structure for writing. The magnetic structure includes a non-magnetic layer, a first magnetic layer electroplated adjacent the non-magnetic layer, a second magnetic layer electroplated adjacent the first magnetic layer, and a third magnetic layer electroplated adjacent the second magnetic layer. The first magnetic layer has a first saturation magnetization and a first coercivity. The second magnetic layer has a second saturation magnetization and a second coercivity. The third magnetic layer has a first saturation magnetization and a first coercivity.

The present invention relates to a magnetic structure. The magnetic structure includes at least 2 first repeating units. The first repeating unit includes an electroplated first magnetic layer and an electroplated second magnetic layer. The electroplated first magnetic layer is adjacent the electroplated second magnetic layer. The electroplated first magnetic layer has a first coercivity and a first saturation magnetization. The electroplated second magnetic layer has a second coercivity and a second saturation magnetization.

The present invention relates to a magnetic structure for writing. The magnetic structure includes at least 2 first repeating units. The first repeating unit includes a first random polycrystalline magnetic layer and a second random polycrystalline magnetic layer. The first random polycrystalline magnetic layer is adjacent the second random polycrystalline magnetic layer. The first random polycrystalline magnetic layer has a first coercivity and a first saturation magnetization. The second random polycrystalline magnetic layer has a second coercivity and a second saturation magnetization.

### BRIEF DESCRIPTION OF THE DRAWINGS

FIG. 1 is a top plan view of an exemplary disc drive with which embodiments of the present invention are useful.

FIG. 2 is a simplified exemplary cross-sectional view of a magnetic structure in accordance with various embodiments of the invention.

FIG. 3 is a simplified exemplary cross-sectional view of a magnetic structure in accordance with various embodiments of the invention.

FIG. 4 is a simplified exemplary cross-sectional view of a magnetic head in accordance with various embodiments of the invention.

FIG. 5 is a portion of the top pole depicted in FIG. 4.

FIG. 6 depicts the saturation magnetization (Bₛ(T)) versus the thickness ratio, t_{2.4T CoFe}/t_{1.8T CoNiFe}.

FIG. 7 is a simplified exemplary cross-sectional view of a magnetic structure in accordance with various embodiments of the invention.

FIGS. 8(a), 8(b), 8(c), and 8(d) are hysteresis curves for magnetic structures in accordance with various embodiments of the invention with different numbers of layers making up the magnetic structure.

FIG. 9 shows the relationship between the number of layers for a magnetic structure versus the coercivity of the magnetic structure.

FIG. 10 shows the thickness ratio between the 2.4 T CoFe layers and the 1.8 T CoNiFe layers for a magnetic structure according to the various embodiments of the invention versus the coercivity of the magnetic structure.

FIGS. 11(a), 11(b), 11(c), and 11(d) illustrate the formation of a magnetic structure according to various embodiments of the invention.

### DETAILED DESCRIPTION OF EXEMPLARY EMBODIMENTS

In the following description of exemplary embodiments, reference is made to the accompanying drawings, which form a part hereof, and in which is shown by way of illustration specific embodiments in which the invention may be practiced. It is to be understood that other embodiments may be utilized and structural changes may be made without departing from the scope of the exemplary embodiments of the present invention.

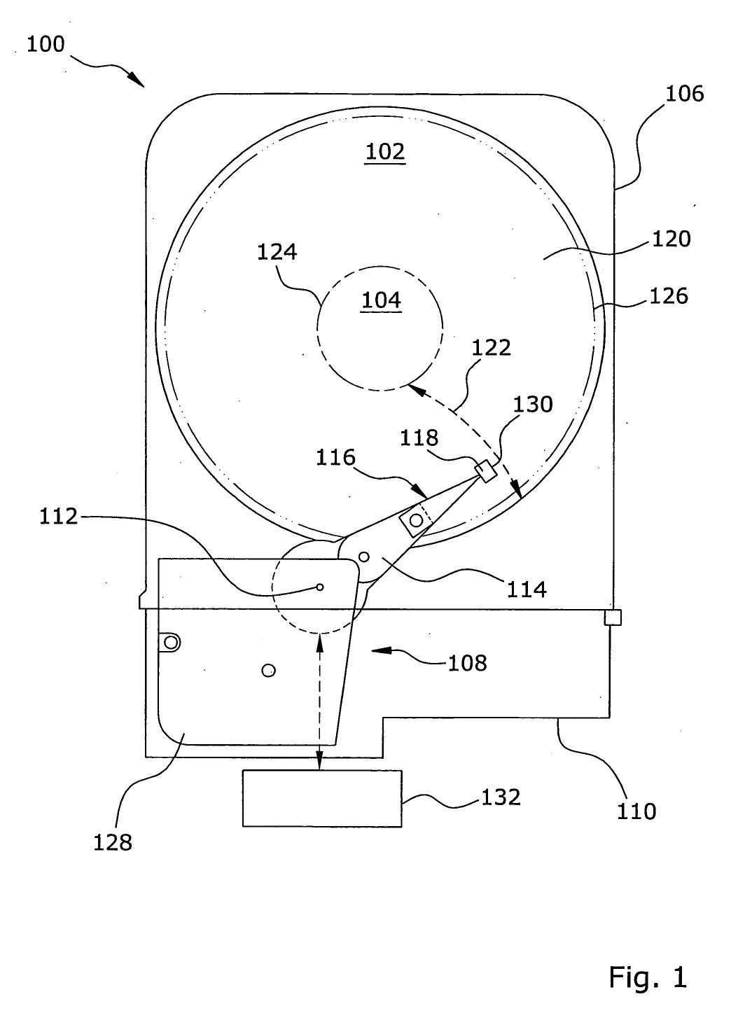

FIG. 1 is a top view of a disc drive 100, with which embodiments of the present invention may be used. Disc drive 100 includes a magnetic disc 102 mounted for rotational movement about an axis 104 and driven by a spindle motor (not shown). The components of disc drive 100 are contained within a housing that includes a base 106 and a cover (not shown). Disc drive 100 also includes an actuator mechanism 108 mounted to a base plate 110 that is pivotally moveable relative to disc 102 about an axis 112. Actuator mechanism 108 includes an actuator arm 114 and a suspension assembly 116. A slider 118 is coupled to suspension assembly 116 through a gimbaled attachment, which allows slider 118 to pitch and roll as it moves above a surface 120 of disc 102. Actuator mechanism 108 is adapted to rotate slider 118 on an arcuate path 122 between an inner diameter 124 and an outer diameter 126 of disc 102. A cover 128 can enclose a portion of actuator mechanism 108. Slider 118 supports a magnetic head 130 at a trailing portion of the slider 118. Magnetic head 130 can include separate reading and writing elements for reading data from, and recording data to disc 102.

During operation, as disc 102 rotates, air (and/or a lubricant) travels under air bearing surfaces (ABS) of slider 118 in a direction approximately parallel to the tangential velocity of disc 102. As the air passes beneath the bearing surfaces, air compression along the air flow path causes the air pressure between disc surface 120 and the bearing surfaces to increase, which creates a hydrodynamic lifting force that counteracts a load force provided by suspension 116 and causes slider 118 to “fly” above, and in close proximity to, disc surface 120. This allows slider 118 to support magnetic head 130 in close proximity to the disc surface 120.

A drive controller 132 controls actuator mechanism 108 through a suitable connection. Drive controller 132 can be mounted within disc drive 100 or located outside of disc drive 100. During operation, drive controller 132 can receive position information indicating a portion of disc 102 to be accessed. Drive controller 132 receives the position information from an operator, from a host computer, or from another suitable controller. Based on the position information, drive controller 132 provides a position signal to actuator mechanism 108. The position signal causes actuator mechanism 108 to pivot about axis 112. This, in turn, causes slider 118 and the magnetic head 130 it is supporting to move radially over disc surface 120 along path 122. Once magnetic head 130 is appropriately positioned, drive controller 132 then executes a desired read or write operation.

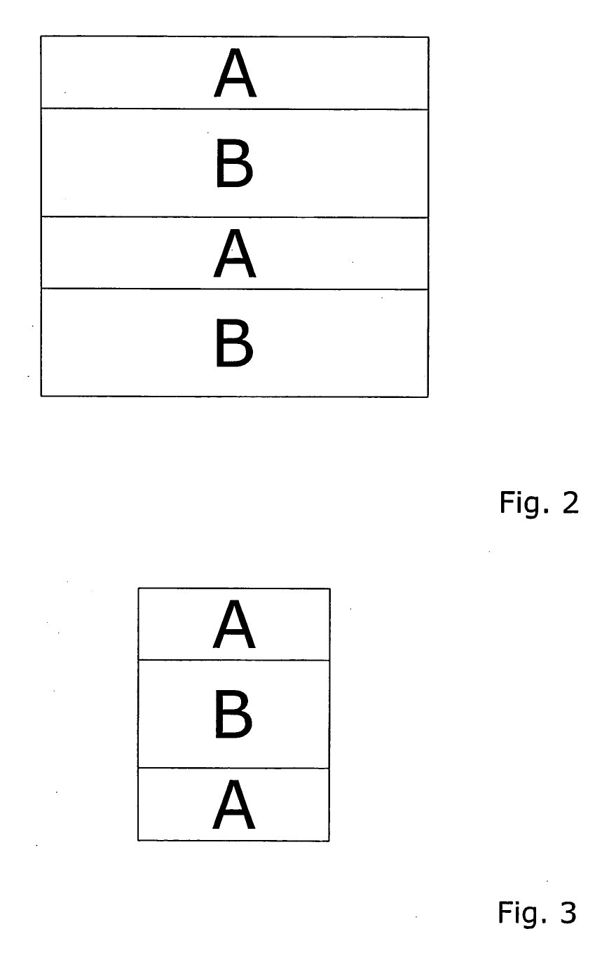

The present invention generally relates to an electroplated magnetic structure formed of at least one repeating unit of layers of magnetic material. The repeating unit can include a first layer of material and a second layer of material. The present invention can include an odd number of layers. The first layer of material has a saturation magnetization of at least 2 tesla (T) and a coercivity of at least 2.0 oerstads (Oe): Alternatively, the saturation magnetization of the first layer can be about 2.2 T to about 2.4 T, about 2.1 T to about 2.3 T, and about 2.3 T. The coercivity of the first layer can be about 5.0 Oe to about 7.5 Oe, about 3.0 Oe to about 8.0 Oe, about 2.5 Oe to about 10.0 Oe, about 2.0 Oe to about 15.0 Oe, and about 9.0 Oe to about 18.0 Oe. The second layer of material has a saturation magnetization lower than the first layer and a coercivity lower than the first layer. The saturation magnetization of the second layer can be about 1.7 T to about 1.9 T, about 1.8, about 1.6 T to about 2.0 T, and about 1.6 T to about 1.8 T. The coercivity of the second layer can be about 0.5 Oe to about 2.0 Oe, about 0.25 Oe to about 1.5 Oe, about 1.0 Oe to about 2.0 Oe, and about 0.1 Oe to about 1.0 Oe. Reference to a layer as a first layer or a second layer has nothing to do with its orientation or placement with respect to the second layer or first layer, respectively. The magnetic structure can include repetitions of a repeating unit. For example, the magnetic structure depicted in FIG. 2 includes two first repeating units. The first repeating unit includes layer A and layer B. An example of the present invention with an odd number of layers is depicted in FIG. 3. The magnetic structure includes first repeating unit, layers A and B, plus an additional layer, A. The additional layer is not limited to layer A, but rather can include any magnetic material. The layers of the magnetic structure can include any combination of cobalt, nickel, iron, and any other suitable magnetic material. The layers generally are not identical in composition, but could be, if desired.

The multiple layer magnetic structure of the invention is provided via electroplating. Electroplating of the multiple layers, e.g. two ferromagnetic materials, 2.4 T CoFe and 1.8 T CoNiFe, was performed using a sequential two-bath process. It is advantageous to use an electroplating process as opposed to a chemical sputtering process when forming a 3-dimensional shape as required, for example, for a magnetic pole in a writing portion of a recording head. It is possible to electroplate through a lithographic mask to form a 3-dimensional shape, without a subsequent ion milling step that is required for chemical sputtering to define the 3-dimensional shape. The simpler electroplating process further provides better control and reduced variability in the critical dimensions of the 3-dimensional structure. Structurally, the sputtered materials are columnar, while the electroplated materials are random polycrystalline. Because of this, the structural differences between sputtered materials and electroplated materials would be recognized at least by the use of transmission electron microscopy (TEM).

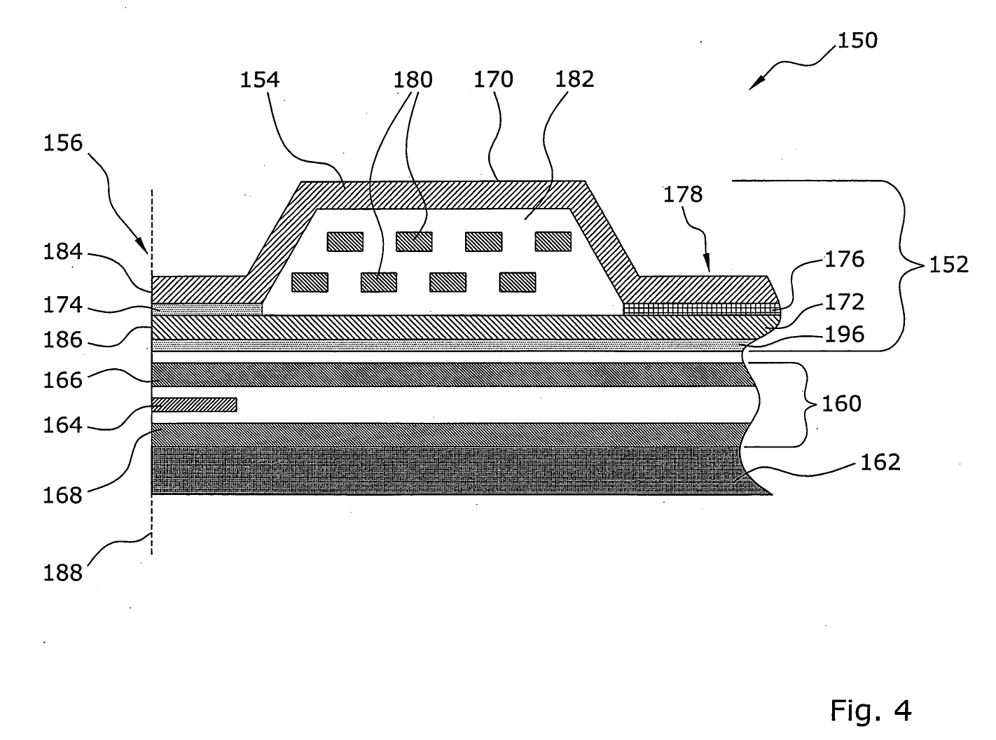

FIG. 4 is an exemplary partial cross-sectional view of a magnetic head 150 that includes a writing element 152 having at least one writing pole 154. The writing pole 154 includes a pole tip portion 156. The writing pole 154 as well as any portion of the writing pole 154, for example the pole tip portion 156, can be formed in accordance with the magnetic structure of the present invention, as will be discussed in greater detail below.

In accordance with one embodiment of the invention, magnetic head 150 includes a reading element 160 formed adjacent an insulating substrate 162. Reading element 160 includes a read sensor 164 that is spaced between top shield 166 and bottom shield 168. The top and bottom shields 166 and 168 operate to isolate the read sensor 164 from external magnetic fields that could affect its sensing of bits of data that have been recorded on disc 102 (FIG. 1).

Writing element 152 includes top pole 170 and bottom pole 172, which are separated by a gap layer 174. Gap layer 174 can be formed of a metallic, non-magnetic material, such as aluminum oxide (Al₂O₃) or ruthenium (Ru), for example. Top and bottom poles 170 and 172 are connected by a back gap “via” or portion 176 at a back gap region 178. A conductive coil 180 extends between the top and bottom poles 170 and 172 and around the back gap portion 176, which is not shown in FIG. 4. Alternatively; the conductive coil 180 can wrap around the top pole 170. An insulating material 182 electrically insulates conductive coil 180 from the top and bottom poles 170 and 172, and can be used to form the gap layer 174. The top and bottom poles 170 and 172 include pole tips 184 and 186, respectively, which face disc surface 120 (FIG. 1) and form a portion of an air-bearing surface (ABS) 188.

At least one of the poles 170 or 172 includes a portion having a magnetic structure in accordance with embodiments of the invention. Writing element 152 can be configured for perpendicular recording where the top pole 170 or the bottom pole 172 is formed as the writing pole 154 of the present invention, and is configured to record data to a recording medium, such as disc 102 (FIG. 1), in accordance with conventional perpendicular recording techniques. Alternatively, writing element 152 can be configured for longitudinal recording where both the top pole 170 and the bottom pole 172 are formed as writing poles, at least one of which is formed as a writing pole 154 of the present invention, where they operate to record data to a recording medium, such as disc 102, in accordance with conventional longitudinal recording techniques. Accordingly, at least a portion of the top pole 170 and/or the bottom pole 172 of the magnetic head 150 is formed in accordance with the magnetic structure of the present invention. However, in order to simplify the discussion, the magnetic structure of the present invention will be described as being formed as a portion of the top pole 170.

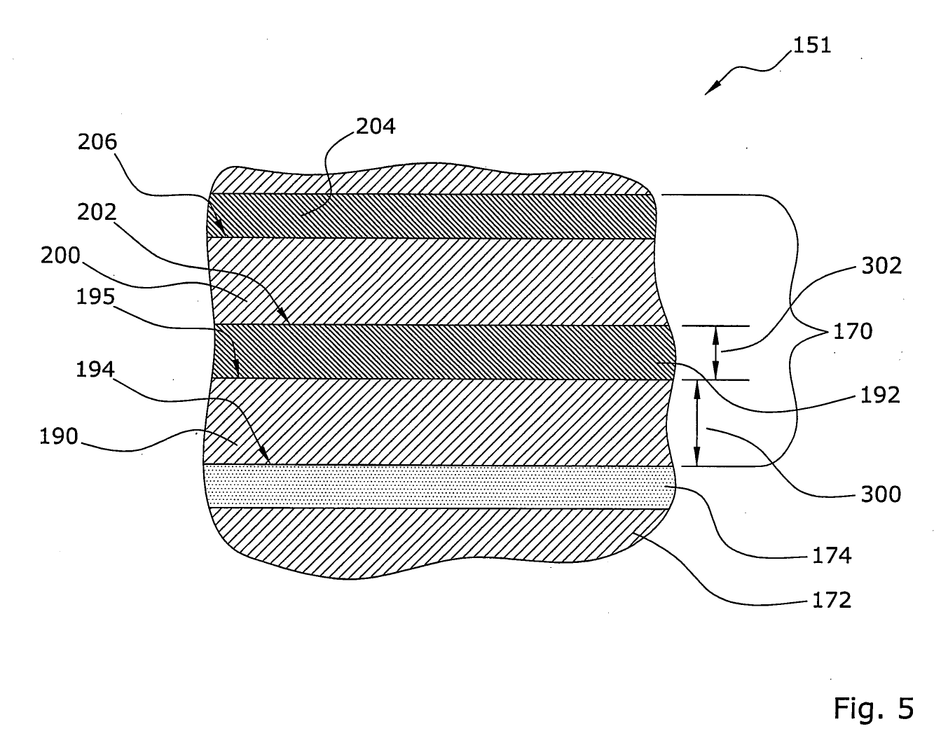

In accordance with an exemplary embodiment of the invention, top pole 170 includes at least a portion 151 that includes the magnetic structure of the present invention, as illustrated in the magnified cross-sectional view shown in FIG. 5. The magnetic structure can form both poles 170 and 172 of the writing element 152 or portions of one or both poles 170 and 172. In FIG. 5, the magnetic structure of portion 151 includes a first magnetic layer 190 and a second magnetic layer 192. The first magnetic layer 190 is formed adjacent a top surface 194 of gap layer 174 and has a first saturation magnetization and a first coercivity. The second magnetic layer 192 is formed adjacent the first magnetic layer 190 and has a second saturation magnetization and a second coercivity. In accordance with an exemplary embodiment of the invention, the first saturation magnetization and the first coercivity of the first magnetic layer 190 are higher than the second saturation magnetization and the second coercivity of the second magnetic layer 192, respectively. Alternatively, the second magnetization and the second coercivity of the second magnetic layer 192 are higher than the first saturation magnetization and the first coercivity of the first magnetic layer 190, respectively. The first magnetic layer 190 and the second magnetic layer 192 make up a first repeating unit. The magnetic structure can include multiple first repeating units. The magnetic structure can include repeating units other than the first repeating unit.

In accordance with an exemplary embodiment of the invention, the first and second magnetic layers 190 and 192 are formed using an electrodeposition process, i.e. electroplated. The properties of the individual layers, e.g. 190 and 192, as used herein, refer to the properties of the magnetic material forming the individual layers when the layer is isolated, or otherwise not affected by external influences, such as adjoining magnetic materials.

It should be understood that bottom pole 172 can also include the magnetic structure provided in FIG. 5 by electroplating the first magnetic layer to a metallic layer 196, shown in FIG. 4. Additional magnetic layers, such as second magnetic layer 192 can then be electroplated to the first magnetic layer 190 in order to form the magnetic structure of the present invention at the pole tip portion of bottom pole 172. The magnetic structure is not limited to the pole tip portion of the bottom pole, i.e. the entire bottom pole can include the magnetic structure.

An exemplary magnetic structure of the invention includes at least two first repeating units, as shown in FIG. 2 and FIG. 5. The second first repeating unit includes third magnetic layer 200 and fourth magnetic layer 204. In one embodiment, the saturation magnetization and the coercivity of the first magnetic layer 190 are approximately equal to that of the third magnetic layer 200, and the saturation magnetization and the coercivity of the second magnetic layer 192 are approximately equal to that of the fourth magnetic layer 204.

The thicknesses 300 and 302 of the first and second magnetic layers 190 and 192, respectively, are selected such that the magnetic structure behaves as a single phase magnet as a result of exchange coupling between the first and the second magnetic layers 190 and 192. The multiple repeating units are obtained by electroplating the multiple layers making up the complete magnetic structure. The resultant properties of the complete magnetic structure include an overall saturation magnetization that is between the first and the second saturation magnetizations and an overall coercivity that is between the first and the second coercivities.

$${B}_{s} = \frac{{B}_{s 1} {t}_{1} + {B}_{s 2} {t}_{2}}{{t}_{1} + {t}_{2}} \qquad Eq . 1$$

The overall saturation magnetization (Bₛ) of the multiple layer magnetic structure can be estimated by Equation 1, where Bₛ₁ and t₁, respectively, represent the first saturation magnetization and the thickness of the first magnetic layer 190, and Bₛ₂ and t₂, respectively, represent the second saturation magnetization and the thickness of the second magnetic layer 192. The overall saturation magnetization is not dependent upon the number of repeating units.

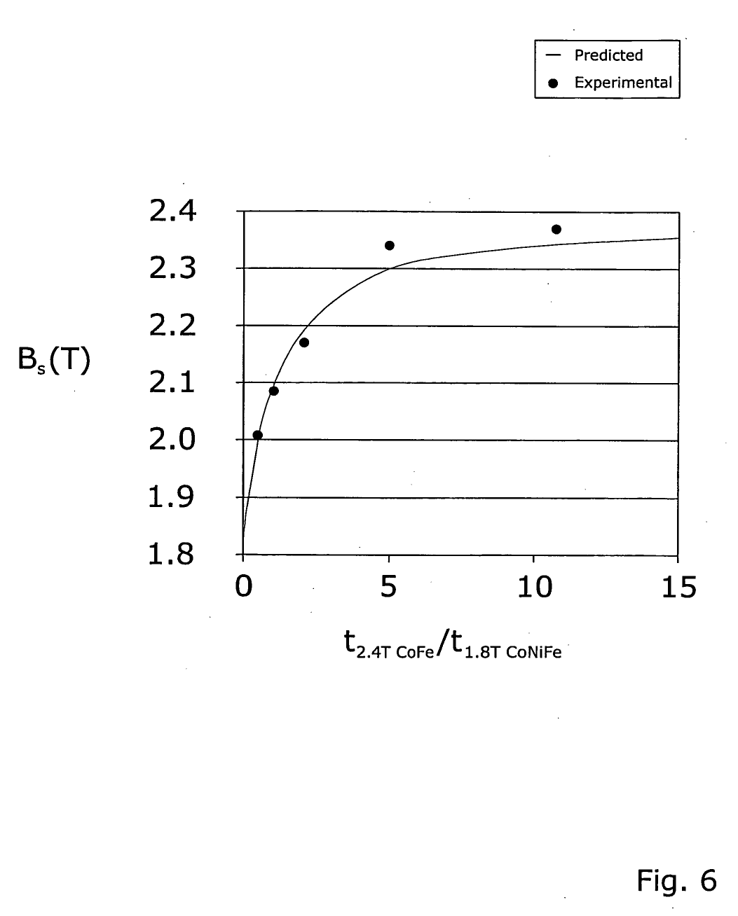

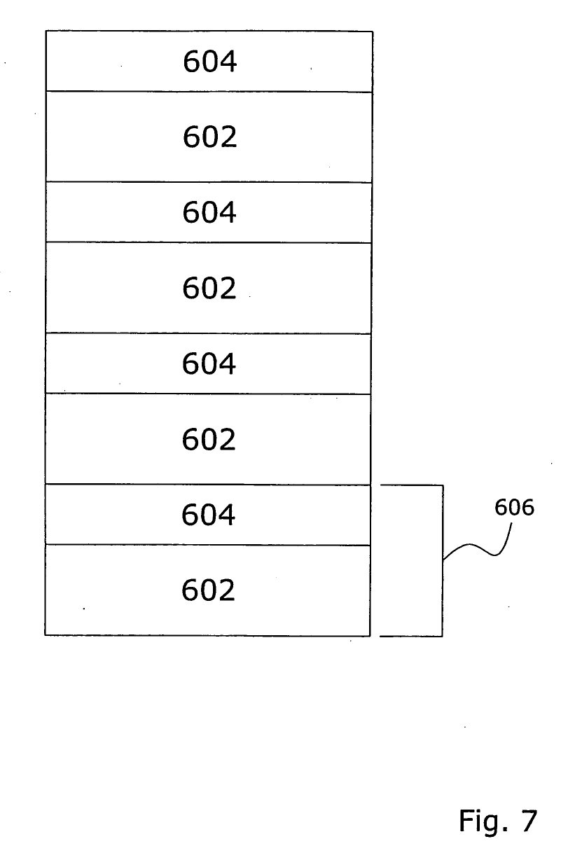

FIG. 6 illustrates predicted Bs values based on Equation 1 and measured Bs values corresponding to the respective electroplated magnetic structure, which are in agreement with the predicted values of the magnetic saturation. The magnetic structure includes a first magnetic layer 602 and a second magnetic layer 604, which make up a first repeating unit 606. The first repeating unit 606 is repeated four times, as illustrated in FIG. 7. The first magnetic layer 602 includes CoFe and has a saturation magnetization of 2.4 T. The second magnetic layer includes CoNiFe and has a saturation magnetization of 1.8 T. Preferably, the overall saturation magnetization Bₛ of the magnetic structure is in the range of about 2.0 T to about 2.35 T, which can be achieved when the thickness ratio of the 2.4 T material to the 1.8 T material is between about 0.4 and about 12.

In accordance with an exemplary embodiment of the invention, the magnetic structure has a total thickness of about 0.15 micrometers to about 3.0 micrometers, about 0.3 micrometers to about 1.5 micrometers, about 0.6 micrometers to about 1.0 micrometer, and about 0.5 micrometers to about 1.5 micrometers. The thickness ratio of the first layer to the second layer is between about 0.4 to about 12.0, about 0.2 to about 20.0, and about 0.8 to about 6.0. The thickness ratio depends on the desired overall saturation magnetization and the saturation magnetization of the individual layers making up the magnetic structure. Equation 1, above, illustrates this point. Consequently, any range of thicknesses is acceptable, but depends on the desired overall saturation magnetization and the materials being used to make the magnetic structure.

The various properties, e.g. coercivity, saturation magnetization, stress, magnetostriction, of the overall magnetic structure can be manipulated to desirable quantities by varying the number of repeating units and the thickness ratio of the magnetic layers, which make up the repeating unit. For example, as discussed above, FIG. 6 illustrates how the thickness ratio between a first magnetic layer and a second magnetic layer effects the saturation magnetization, which is predicted by Equation 1.

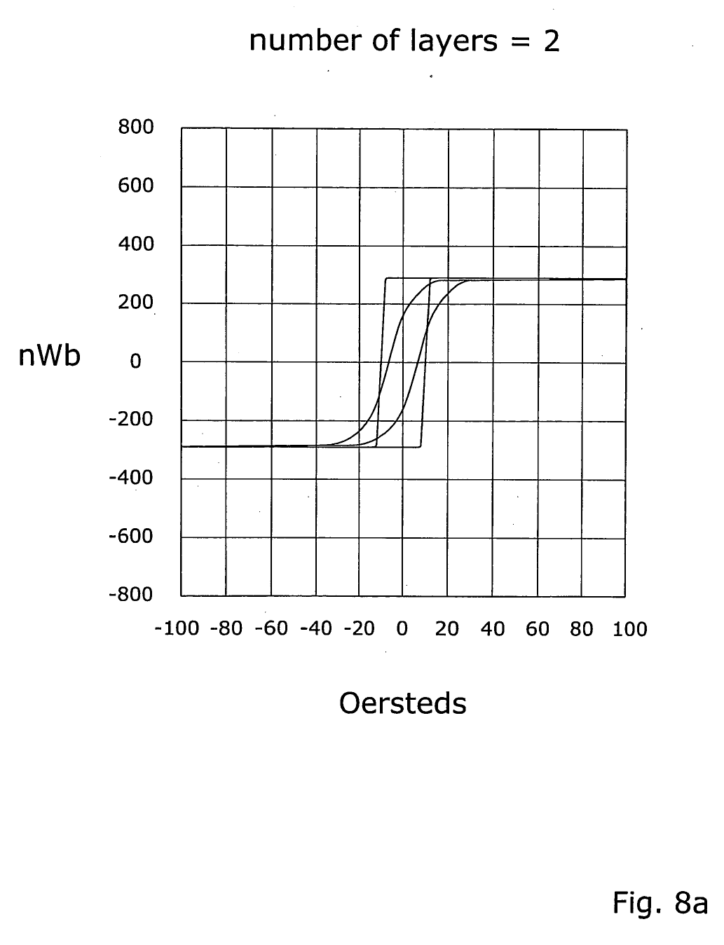

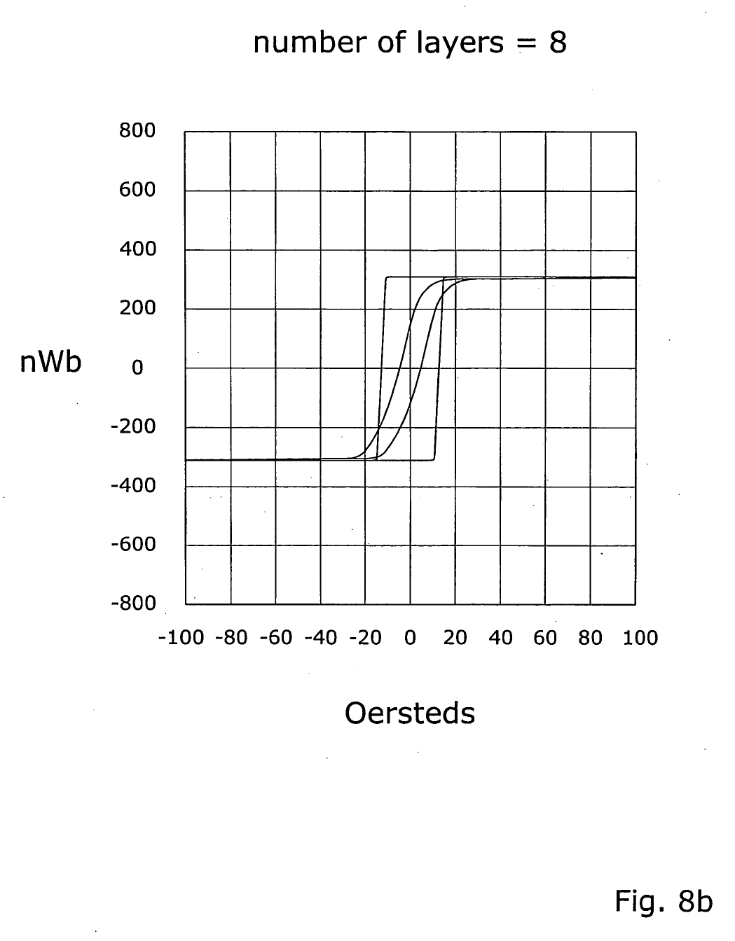

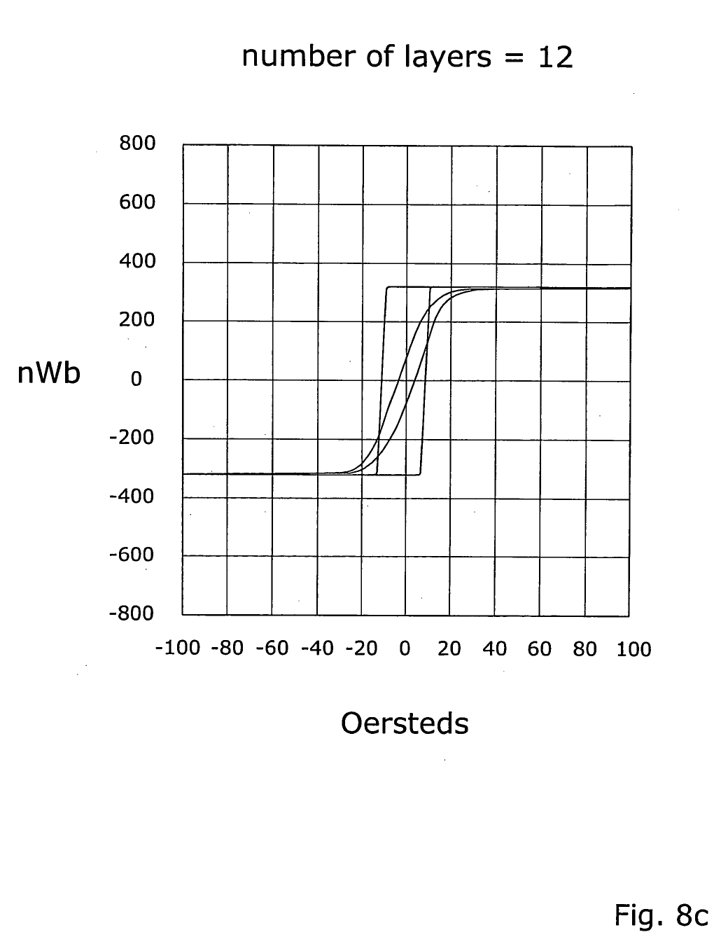

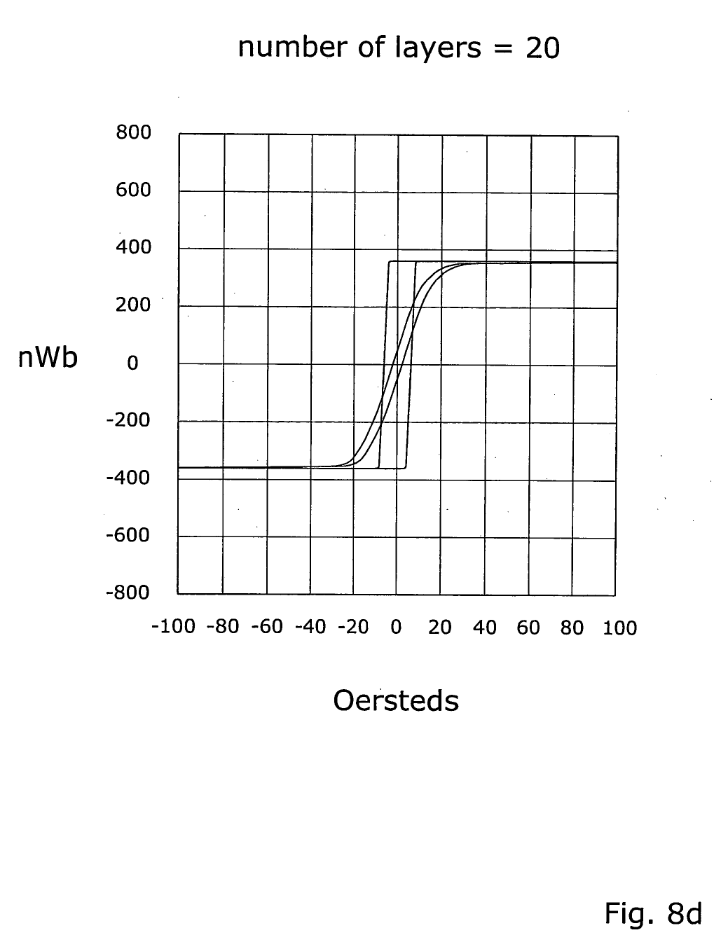

The coercivity of the magnetic structure decreases as the number of first repeating units increases. The remanent magnetization of the magnetic structure decreases as the number of first repeating units increases. FIGS. 8(a), 8(b), 8(c), and 8(d) illustrate that the remanent magnetization decreases as the number of first repeating units increases. The total thickness for the magnetic structure regarding FIGS. 8(a), 8(b), 8(c), and 8(d) is about 1 micrometer. The first magnetic layer is CoFe, which has a magnetic saturation of about 2.4 T. The second magnetic layer is CoNiFe, which has a magnetic saturation of about 1.8 T. The overall magnetic saturation of the magnetic structure is about 2.2 T. The thickness ratio between the first magnetic layer and the second magnetic layer is about 2.0. The total number of magnetic layers for the magnetic structure of FIGS. 8(a), 8(b), 8(c), and 8(d) is 2, 8, 12, and 20, respectively, which corresponds to 1, 4, 6, and 10 first repeating units.

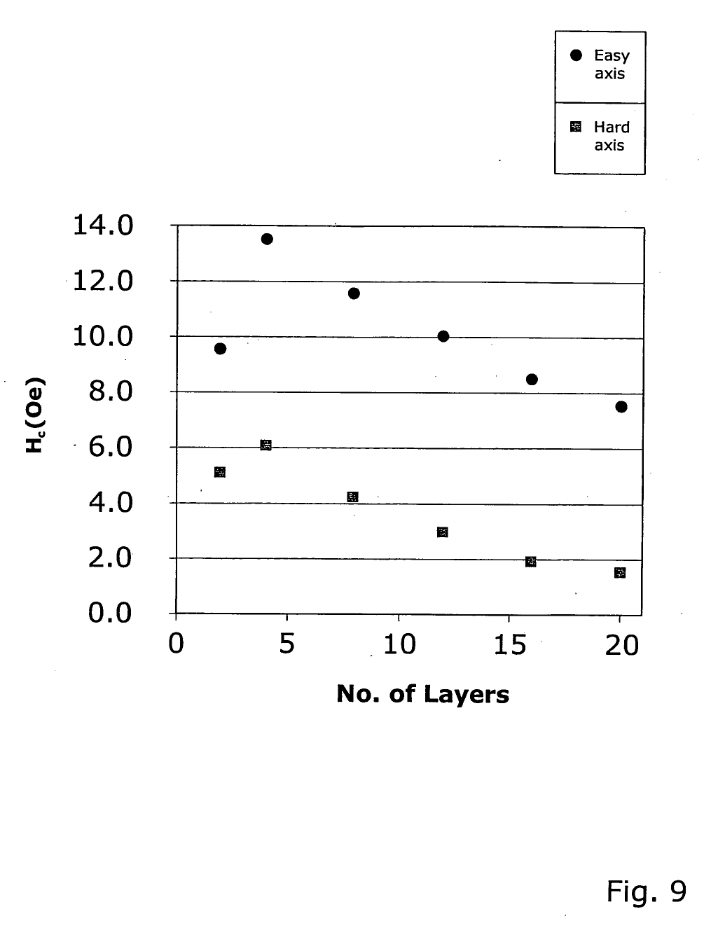

FIG. 9 illustrates the correlation between the total number of layers for the magnetic structure and the overall coercivity of the magnetic structure for both the easy axis and the hard axis. The magnetic structure includes a first magnetic layer of CoFe, which has a magnetic saturation of about 2.4 T, and a second magnetic layer of CoNiFe, which has a magnetic saturation of about 1.8 T. The overall magnetic saturation of the magnetic structure is about 2.2 T. The thickness ratio between the first magnetic layer and the second magnetic layer, which make up the first repeating unit, is about 2.0. The number of first repeating units is half the number of layers for FIG. 9, because the first repeating unit has two layers, e.g. 12 layers corresponds to 6 first repeating units. FIG. 9 depicts the general trend of a decreasing coercivity for both the hard axis and the easy axis of the magnetic structure as the number of laminations or repeating units increases.

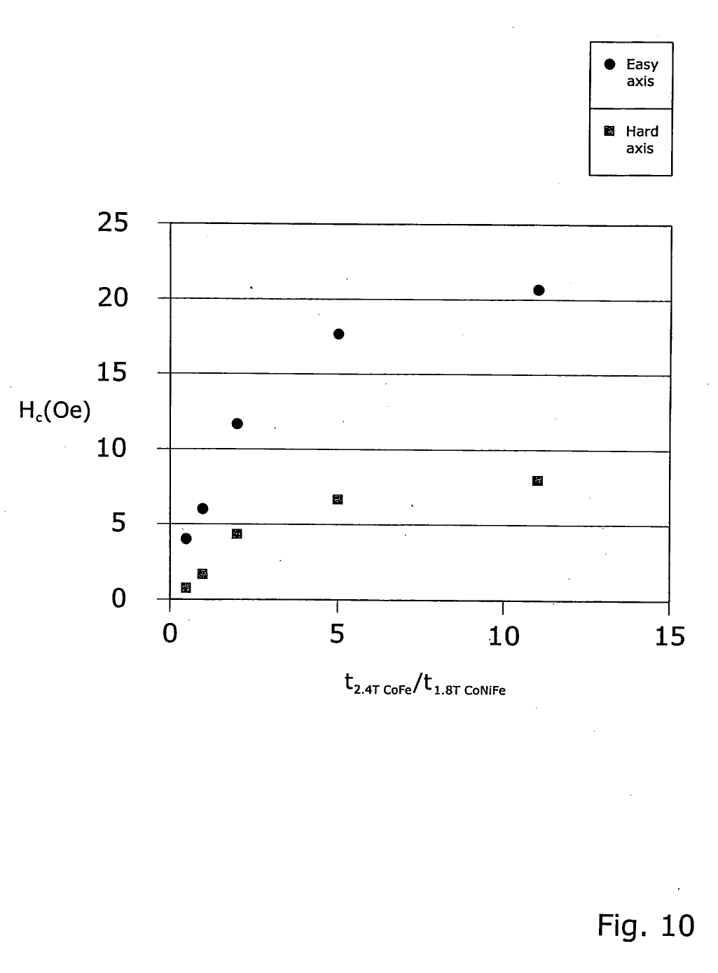

FIG. 10 illustrates the correlation between the thickness ratio of a first magnetic layer to a second magnetic layer and the overall coercivity of the magnetic structure for both the easy axis and the hard axis. The magnetic structure includes a first magnetic layer of CoFe, which has a magnetic saturation of about 2.4 T, and a second magnetic layer of CoNiFe, which has a magnetic saturation of about 1.8 T. The overall magnetic saturation of the magnetic structure is depicted in FIG. 6. The total number of layers is 8, which corresponds to 4 first repeating units. The first repeating unit includes the first magnetic layer and the second magnetic layer. FIG. 10 shows the general trend that both the easy axis and hard axis coercivity increase as the thickness ratio between the first magnetic layer and the second magnetic layer increases.

The magnetostriction of a multiple layer film can be manipulated according to the following formula:
λₛ=(t₁λₛ₁+t₂λₛ₂)/(t₁+t₂) Eq. 2
where λₛ is the average magnetostriction of the multiple layer film, λₛ₁ is the magnetostriction of a first magnetic layer, λₛ₂ is the magnetostriction of a second magnetic layer, t₁ is the thickness of the first magnetic layer, and t₂ is the thickness of the second magnetic layer. The multiple layer film can include multiple repeating units, which include the first magnetic layer and the second magnetic layer.

Embodiments of the present invention can employ the relatively hard and soft magnetic alloys listed in Table 1 for the first and second magnetic layers 190 and 192. In an exemplary embodiment, either the first magnetic layer 190 or the second magnetic layer 192 is formed of one of the materials having a relatively high saturation magnetization (Bₛ greater than 2.3 T) and a high coercivity (greater than 3.0 Oe), while the other magnetic layer is formed of a material having a lower saturation magnetization (Bₛ of less than 2.0 T) and a lower coercivity (less than 1.5 Oe).

TABLE 1

| | Property | | | | | |
|---|---|---|---|---|---|---|
| | 2.4 T CoFe | | 2.4 T CoNiFe | | 1.8 T CoNiFe | |
| Composition (Wt. %) | CO₃₅₋₄₅Fe₅₅₋₆₅ | | Co₄₀₋₅₀Ni₁₋₅Fe₅₀₋₅₈ | | CO₆₃₋₇₅Ni₁₁₋₁₅Fe₁₂₋₁₉ | |
| Saturation Magnetization (Bₛ) | 2.4 | T | 2.3-2.4 | T | 1.8-1.85 | T |
| Coercivity (H_{c,e}) | 11.6-18 | Oe | 10-15 | Oe | 0.8-1.4 | Oe |
| Coercivity (H_{c,h}) | 5.0-7.3 | Oe | 3-8 | Oe | 0.1-0.2 | Oe |
| Uniaxial anisotropy | | | 20 | Oe | 15-18 | Oe |
| Magnetostriction | 50-60 × 10⁻⁶ | | 40-50 × 10⁻⁶ | | 2-3 × 10⁻⁶ | |
| Structure/texture | bcc/((110), (200), (211) | | bcc/((110), (200), (211) | | fcc/(111), (200) and | |
| | | | | | fcc-bcc/(110) | |
| Grain size | 14-30 | nm | 32-50 | nm | 8-10 | nm |
| Resistivity | 18-20 | μΩ-cm | 25-30 | μΩ-cm | 15-18 | μΩ-cm |
| Stress | 350 | MPa | 200 | Mpa | 150 | MPa |

In accordance with another embodiment of the invention, the magnetic structure of portion 151 includes a third magnetic layer 200 that is electroplated to a surface 202 of the second magnetic layer 192. The third magnetic layer 200 includes a third saturation magnetization and a third coercivity. In accordance with one embodiment of the invention, the third magnetic layer 200 is formed of the same material that forms the first magnetic layer 190. Accordingly, one embodiment of the magnetic structure utilizes a magnetic material for the first and the third magnetic layers 190 and 200 having saturation magnetizations and coercivities, which are respectively higher than the second saturation magnetization and the second coercivity of the second magnetic layer 192. For example, the first and third magnetic layers 190 and 200 can be formed of one of the 2.4 T materials provided in Table 1, and the second magnetic layer 192 can be formed of the 1.8 T material provided in Table 1.

In accordance with another embodiment of the magnetic structure, the first and third magnetic layers 190 and 200 are formed of a material having a saturation magnetization and coercivity, which are respectively lower than the second saturation magnetization and the second coercivity. For example, the first and the third magnetic layers can be formed of the 1.8 T material provided in Table 1, and the second magnetic layer 192 can be formed of one of the 2.4 T materials provided in Table 1.

The thicknesses of the first magnetic layer 190, the second magnetic layer 192, and the third magnetic layer 200 are selected such that the magnetic structure operates as a single phase magnet as a result of exchange coupling between the layers. In accordance with one embodiment of the invention, none of the magnetic layers has a thickness that exceeds 1.5 micrometers and the overall thickness of the magnetic structure is in the range of 0.25-3.0 micrometers.

In accordance with another embodiment of the invention, the magnetic structure of portion 151 of the writing pole includes a fourth magnetic layer 204 formed on a surface 206 of the third magnetic layer 200. The thicknesses of the first magnetic layer 190, the second magnetic layer 192, the third magnetic layer 200, and the fourth magnetic layer 204 are selected such that the magnetic structure operates as a single phase magnet as a result of exchange coupling between the layers. In accordance with one embodiment of the invention, none of the magnetic layers has a thickness that exceeds about 1.5 micrometers and the overall thickness of the magnetic structure is in the range of about 0.25 to about 3.0 micrometers.

The fourth magnetic layer has a fourth saturation magnetization and a fourth coercivity. In accordance with one embodiment of the invention, the fourth magnetic layer 204 is formed of the same material that forms the second magnetic layer 192. Accordingly, one embodiment of the magnetic structure utilizes a magnetic material for the second and fourth magnetic layers 192 and 204 having saturation magnetizations and coercivities, which are respectively lower than the saturation magnetizations and coercivities of the first and third magnetic layers 190 and 200. For example, the first and third magnetic layers 190 and 200 can be formed of one of the 2.4 T materials provided in Table 1, and the second and the fourth magnetic layers 192 and 204 can be formed of the 1.8 T material provided in Table 1.

In accordance with another embodiment of the magnetic structure, the second and fourth magnetic layers 192 have saturation magnetizations and coercivities that are respectively higher than the saturation magnetizations and coercivities of the first and the third magnetic layers 190 and 200. Accordingly, the first and the third magnetic layers 190 and 200 can be formed of the 1.8 T material provided in Table 1, and the second and the fourth magnetic layers 192 and 204 can be formed of one of the 2.4 T materials provided in Table 1, for example.

Another aspect of the present invention is directed to a method of forming the embodiments of the magnetic structure described above and, more particularly, to a method of forming a magnetic head that includes a writing pole having the magnetic structure.

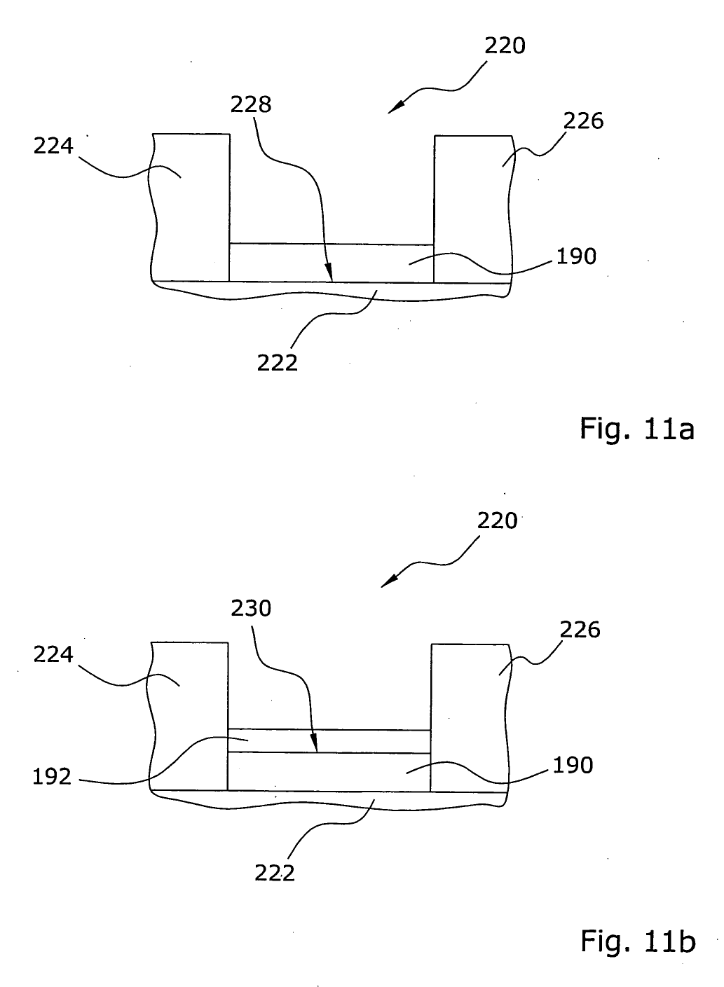

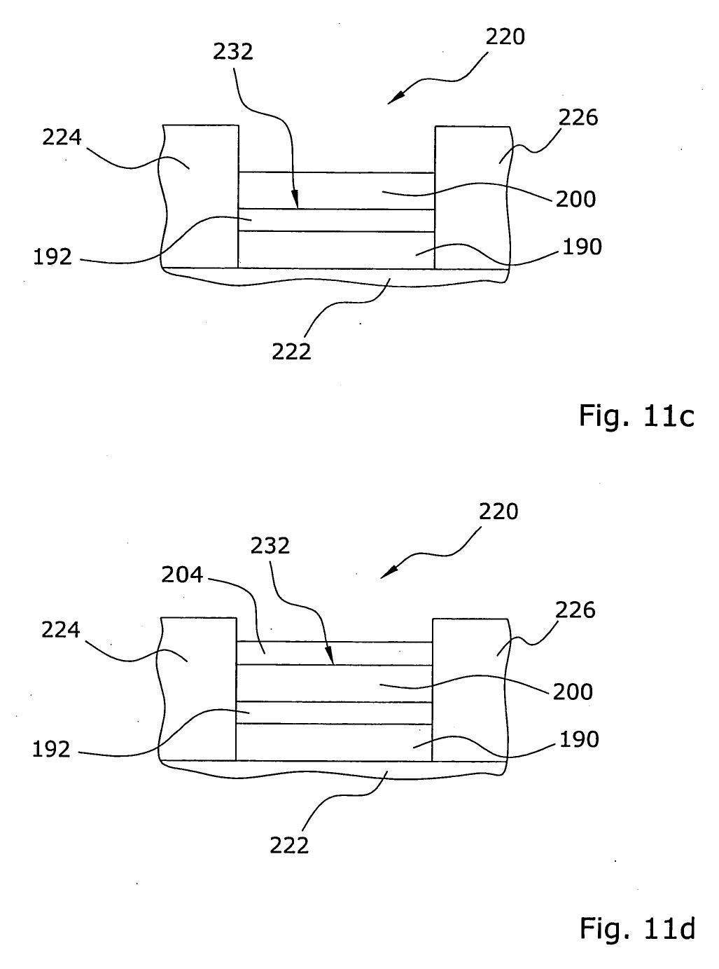

FIGS. 11A, 11B, 11C, and 11D illustrate the formation of an exemplary magnetic structure in accordance with various embodiments of the invention. Initially, a trench 220 is formed on top of a metallic, non-magnetic layer 222, such as gap layer 174 or layer 196, described above. Trench 220 is defined by side walls 224 and 226, which are preferably formed of a non-metallic material, such as photoresist. The first magnetic layer 190 is then formed on a surface 228 of layer 222 within trench 220 through an electroplating process. As illustrated in FIG. 11B, the structure of FIG. 11A is immersed in a different electroplating cell and the second magnetic layer 192 is electroplated to a surface 230 of the first magnetic layer 190 within the trench 220 to complete the formation of the two-layered magnetic structure discussed above.

The formation of the three-layered magnetic structure discussed above is completed by immersing the structure of FIG. 11B in another electroplating cell, such as the electroplating cell used to electroplate the first magnetic layer 190 to layer 222, in order to electroplate the third magnetic layer 200 to a surface 232 of the second magnetic layer 192 within trench 220. Likewise, the four-layered magnetic structure discussed above can be formed by immersing the structure of FIG. 11C into another electroplating cell, such as the electroplating cell used to form the second magnetic layer 192, to form the fourth magnetic layer 204 on the surface 234 of the third magnetic layer 200 within trench 220. Additional magnetic layers can be electroplated onto the structure of FIG. 11D to form a magnetic structure having more than four magnetic layers.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed.

What is claimed is:

1. A magnetic structure for writing, the magnetic structure comprising:
a non-magnetic layer;
a first magnetic layer electroplated adjacent the non-magnetic layer, the first magnetic layer having a first saturation magnetization and a first coercivity;
a second magnetic layer electroplated adjacent the first magnetic layer, the second magnetic layer having a second saturation magnetization and a second coercivity; and
a third magnetic layer electroplated adjacent the second magnetic layer, the third magnetic layer having the first saturation magnetization and the first coercivity.

2. The magnetic structure according to claim 1, wherein the first saturation magnetization is higher than the second saturation magnetization, and the first coercivity is higher than the second coercivity.

3. The magnetic structure according to claim 1, wherein the first saturation magnetization is lower than the second saturation magnetization, and first coercivity is lower than the second coercivity.

4. The magnetic structure according to claim 1, wherein the first magnetic layer and third magnetic layer include CoNiFe, and the second magnetic layer includes CoFe.

5. The magnetic structure according to claim 1, wherein the first magnetic layer and third magnetic layer include CoFe, and the second magnetic layer includes CoNiFe.

6. The magnetic structure according to claim 1 comprising at least 2 first repeating units, wherein the first repeating unit includes the first magnetic layer and the second magnetic layer.

7. The magnetic structure according to claim 1, wherein the first magnetic layer and third magnetic layer have a thickness, t₁, and the second magnetic layer has a thickness, t₂, and t₁/t₂ is at least 0.4.

8. A magnetic structure, the magnetic structure comprising:
at least 2 first repeating units, the first repeating unit includes an electroplated first magnetic layer and an electroplated second magnetic layer, the electroplated first magnetic layer is adjacent the electroplated second magnetic layer; and
the electroplated first magnetic layer has a first coercivity and a first saturation magnetization, and the electroplated second magnetic layer has a second coercivity and a second saturation magnetization.

9. The magnetic structure according to claim 8, wherein the first repeating units are adjacent to at least one other first repeating unit.

10. The magnetic structure according to claim 8 comprising at least 6 first repeating units.

11. The magnetic structure according to claim 8, wherein the electroplated first magnetic layer includes CoNiFe, and the electroplated second magnetic layer includes CoFe.

12. The magnetic structure according to claim 8, wherein the first coercivity is higher than the second coercivity, and the first saturation magnetization is higher than the second saturation magnetization.

13. The magnetic structure according to claim 8, wherein the electroplated first magnetic layer has thickness, t₁, and the electroplated second magnetic layer has a thickness, t₂, and t₁/t₂ is at least 0.3.

14. The magnetic structure according to claim 13, wherein t₁/t₂ is at least 1.

15. The magnetic structure according to claim 8, wherein the magnetic structure is a writing pole for a magnetic head.

16. The magnetic structure according to claim 15, wherein the electroplated first magnetic layer includes CoNiFe, and the electroplated second magnetic layer includes CoFe.

17. A magnetic structure for writing, the magnetic structure comprising:
at least 2 first repeating units, the first repeating unit includes a first random polycrystalline magnetic layer and a second random polycrystalline magnetic layer, the first random polycrystalline magnetic layer is adjacent the second random polycrystalline magnetic layer; and
the first random polycrystalline magnetic layer has a first coercivity and a first saturation magnetization, and the second random polycrystalline magnetic layer has a second coercivity and a second saturation magnetization.

18. The magnetic structure according to claim 17, wherein the first random polycrystalline magnetic layer includes CoNiFe, and the second random polycrystalline magnetic layer includes CoFe.

19. The magnetic structure according to claim 17 comprising at least 8 first repeating units.

20. The magnetic structure according to claim 17, wherein the first repeating units are adjacent at least one other first repeating unit.
